(19) United States
(12) Patent Application Publication
(10) Pub. No.: US 2005/0201081 A1
(43) Pub. Date: Sep. 15, 2005

(54) Night light with sparkle and glitter

(75) Inventor: Floyd William Brady, Soquel, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Salamander Graphix, Inc., Watsonville, CA (US)

(21) Appl. No.: 10/799,920

(22) Filed: Mar. 12, 2004

(51) Int. Cl. F21V 9/12; G09F 19/00

(52) U.S. Cl. 362/101; 362/318; 40/409

(57) ABSTRACT

A night light that includes liquid and glitter particles therein is illuminated by the light. The night light includes a base having two leads for coupling to an electrical wall outlet and a light bulb coupled with a base. A container includes the liquid and glitter therein and is coupled to the base. At least the container is made of a heat resistant plastic. Light from the light bulb illuminates the liquid and thereby heats the liquid causing currents therein, which move the glitter particles.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention relates to night lights that plug directly into an electrical wall outlet, and more particularly, to a night light that includes a container that includes liquid and glitter therein above the light bulb.

2. Description of the Prior Art

Night lights are common in many homes, hotels, business, etc. There are often used to provide a small amount of light during the night or other dark periods. Since most of the time night lights are not removed during the day or other periods of light, it is desirable to have a night light provide some type of decoration. Thus, many night lights are decorative. Many are decorative whether they are on or off.

It is also desirable to provide night lights that may or may not be used to necessarily provide light, but rather are exclusively for decoration. However, such night lights, because they generally plug directly into an electrical outlet on the wall, must meet stringent safety regulations and parameters. Thus, materials must be designed and selected and the overall design of the night light must be carefully planned, with the actual construction of the night light being equally important.

### SUMMARY OF THE INVENTION

The present invention provides a night light for coupling to an electrical wall outlet that includes a base including two leads for coupling to the wall outlet, a light bulb coupled to the base and a container including liquid and glitter therein coupled to the base.

In accordance with one aspect of the present invention, the container comprises plastic consisting of temperature resistant plastic.

In accordance with another aspect of the present invention the plastic consists of lexan.

In accordance with a further aspect of the present invention, the container comprises a body and a separate bottom.

In accordance with yet another aspect of the present invention, the container comprises a single piece with an open top and a separate cap is placed over the open top.

In accordance with a further aspect of the present invention, the container is located above the light bulb.

In accordance with yet another aspect of the present invention, the container is coupled to the base with an extension piece.

In accordance with a further aspect of the present invention, the extension piece is coupled to the base with a collar.

In accordance with another aspect of the present invention, the container comprises a single piece.

The present invention also provides a method of producing light with a night light that includes a light bulb and moving glitter particles within a liquid within a container adjacent the light bulb. The method includes coupling the night light to an electrical wall outlet and turning on the night light such that power is delivered to the light bulb, thereby illuminating the light bulb. The method also includes heating the liquid with the illuminated light bulb such that the liquid moves within the container thereby causing the glitter particles to move.

Other features and advantages of the present invention will be apparent in view of the following detailed description of preferred exemplary embodiments.

### BRIEF DESCRIPTION OF THE DRAWINGS

FIG. 1 is a perspective view of a night light in accordance with the present invention; and

FIG. 2 is an exploded view of the night light illustrated in FIG. 1.

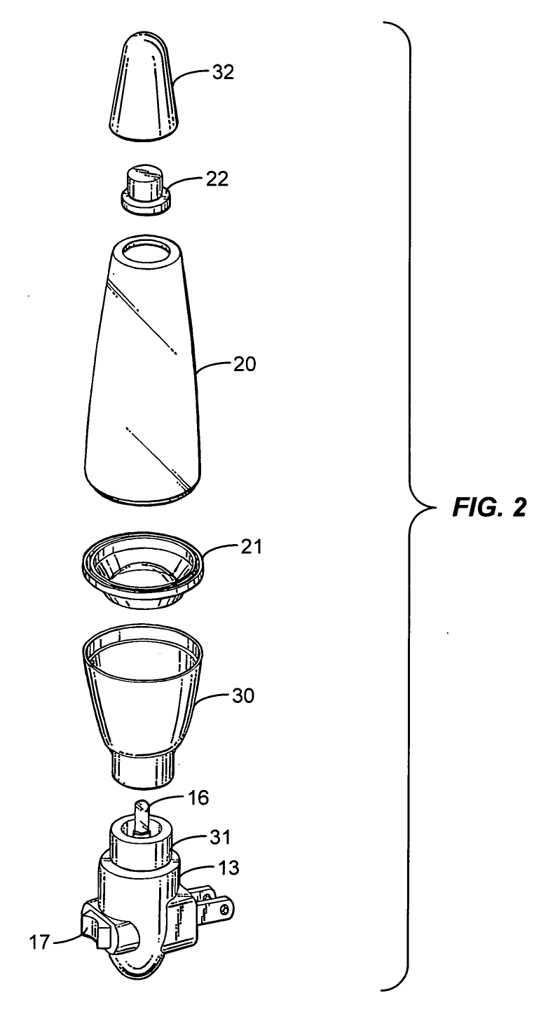

### DETAILED DESCRIPTION OF THE INVENTION

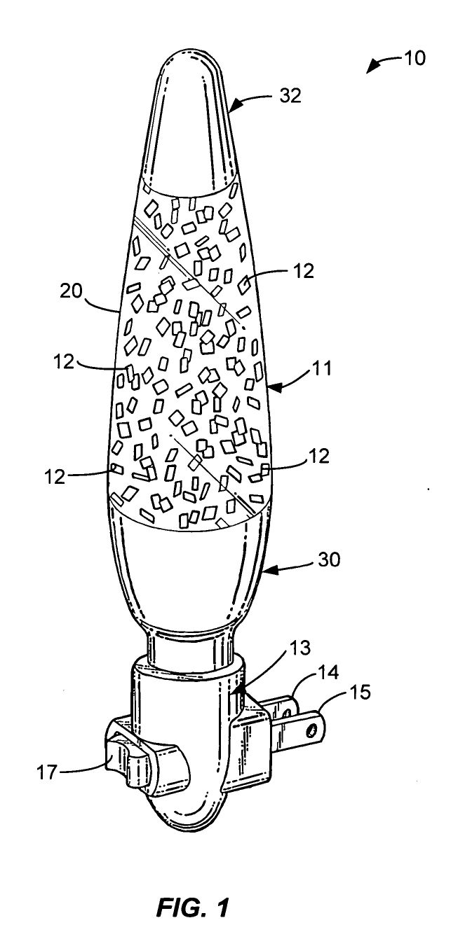

FIG. 1 illustrates a night light 10 that includes a container 11 for housing liquid. Within the liquid is a decorative substance or particles 12. In a preferred embodiment, the particles are reflective, thereby providing a glitter effect when hit by light. Those skilled in the art will understand that other substances or particles may be provided within the liquid in order to provide glitter or decorations such as a viscous or “lava” type effect within the liquid.

Night light 10 further includes a base 13 and includes two leads 14 and 15 for plugging into or coupling to a standard electrical wall outlet. Within base 13 is a light bulb 16 that may be lit with power from the wall outlet. A power switch 17 is provided on the base for turning the night light on and off. The base is preferably a standard night light base known in the industry.

In a preferred embodiment, container 11 is made up of a bottle 20 and a bottom 21 coupled thereto. Additionally, a cap 22 is included over a top of the bottle and is placed thereon after the liquid and glitter is placed therein. Preferably, the bottle, bottom and cap consist of a temperature resistant or heat resistant plastic. An example of such a plastic is lexan. The plastic for at least the bottle is clear so that the liquid and glitter may be observed.

Preferably, the container is coupled to the base with an extension 30 by coupling the extension to the bottle and to a collar 31. A decorative top 32 is also preferably provided. The top, extension and collar are also preferably made of heat or temperature resistant plastic such as lexan. The extension, collar and top, for decorative purposes, and to help hide the light bulb, are preferably not clear. However, they may be clear or cloudy if desired for decorative purposes

The various components are preferably coupled to one another with a heat resistant adhesive such as, for example, a heat resistant adhesive available from Tex Year Industries, Inc. This adhesive is made by using 1663MT(JAPAN DIABOND) SBR as a base material. This adhesive has a flash point of −26 degrees Celsius. Additionally, components may also be screwed with mating threads in addition to the adhesive, which would serve as a sealant. However, the extension should fit snugly with respect to the collar but should be removable to allow access to the light bulb so that it may be replaced when necessary. The collar is preferably coupled to the base with an adhesive or a seal ring, or both.

Additionally, the various components may be blow molded as one piece or injection molded as one piece. However, some portion, either the top or the bottom, of the bottle must be left open to allow for the liquid and glitter particles to be placed inside the container 11, with an appropriate cap or plug sealingly placed over or within the opening so that the liquid is retained within the container.

Thus, the present invention provides a night light that includes a decorative liquid and glitter or other decorative substance therein. The heat from the light heats the liquid, thereby causing currents within the liquid that move the glitter or other decorative particles within the liquid. Additionally, the light shines through the clear portions of the container. Because of the use of a heat resistant plastic and the various seals or the singularility of the bottle, a night light in accordance with the present invention is able to pass the safety requirements of Underwriters Laboratories (UL). Use of other materials, such as a glass bottle, is not able to pass the UL requirements.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principals of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A night light for coupling to an electrical wall outlet, the night light comprising:
a base including two leads for coupling to the wall outlet;
a light bulb coupled to the base; and
a container including liquid and glitter therein coupled to the base.

2. A night light in accordance with claim 1 wherein the container comprises plastic consisting of temperature resistant plastic.

3. A night light in accordance with claim 2 wherein the plastic consists of lexan.

4. A night light in accordance with claim 1 wherein the container comprises a body and a separate bottom.

5. A night light in accordance with claim 1 wherein the container comprises a single piece with an open top and a separate cap is placed over the open top.

6. A night light in accordance with claim 1 wherein the container is located above the light bulb.

7. A night light in accordance with claim 1 wherein the container is coupled to the base with an extension piece.

8. A night light in accordance with claim 7 wherein the extension piece is coupled to the base with a collar.

9. A night light in accordance with claim 1 wherein the container comprises a single piece.

10. A night light for coupling to an electrical wall outlet, the night light comprising:
a base including two leads for coupling to the wall outlet;
a light bulb coupled to the base;
a collar coupled to the base;
an extension coupled to the collar and substantially surrounding the light bulb;
a container including liquid and glitter therein coupled to the extension.

11. A night light in accordance with claim 10 wherein the container comprises plastic consisting of temperature resistant plastic.

12. A night light in accordance with claim 11 wherein the plastic consists of lexan.

13. A night light in accordance with claim 10 wherein the container comprises a body and a separate bottom.

14. A night light in accordance with claim 10 wherein the container comprises a single piece with an open top and a separate cap is placed over the open top.

15. A night light in accordance with claim 10 wherein the container is located above the light bulb.

16. A night light in accordance with claim 10 wherein the container comprises a single piece.

17. A method of producing light with a night light including a light bulb and moving glitter particles within a liquid within a container adjacent the light bulb, the method comprising:
coupling the night light to an electrical wall outlet;
turning on the night light so that power is delivered to the light bulb thereby illuminating the light bulb; and
heating the liquid with the illuminated light bulb such that the liquid moves within the container thereby causing the glitter to move.
